(19) United States
(12) Patent Application Publication
(10) Pub. No.: US 2011/0135111 A1
(43) Pub. Date: Jun. 9, 2011

(54) SPEAKER DEVICE AND AUTOMOBILE

(75) Inventor: Tatsuya Suzuki, Yamagata (JP)

(73) Assignee: Pioneer Corporation, Tokyo (JP)

(21) Appl. No.: 12/995,945

(22) PCT Filed: Jul. 31, 2008
(86) PCT No.: PCT/JP2008/063754

§ 371 Date: Dec. 2, 2010

(51) Int. Cl. H04B 1/00; H04R 9/06

(52) U.S. Cl. 381/86; 381/412

(57) ABSTRACT

A speaker device is provided, in which the rolling of a voice coil and the contact of the voice coil with a magnetic circuit are reduced. The speaker device includes a vibrating body 4, a magnetic circuit 3, and a frame 2 that supports the vibrating body 4 and the magnetic circuit 3. The vibrating body 4 includes a diaphragm 41, a voice coil-supporting member 44 that includes a voice coil 45 wound therearound, and a plurality of edge portions 42 and 43 that vibratably support the voice coil-supporting member 44 on the frame 2. The plurality of edge portions 42 and 43 are substantially identical and disposed above the magnetic circuit 3.

### FIELD OF THE INVENTION

The present invention relates particularly to a speaker device installed in a limited space such as a space inside a door of an automobile and to an automobile provided with the speaker device.

### TECHNICAL BACKGROUND

An exemplary conventional speaker device includes a voice coil wound around a voice coil-supporting member connected to a diaphragm, an edge portion disposed on the voice coil-supporting member, and a damper disposed at the midpoint between the edge portion and the voice coil (see, for example, Patent Document 1). Hereinafter, this art is referred to as a first conventional art.

In another exemplary conventional speaker device, a coil is disposed at an intermediate portion of a voice coil, a diaphragm and a first surround (edge portion) are disposed at the upper end of the voice coil, and a second surround (edge portion) is disposed at the lower end of the voice coil (see, for example, Patent Document 2). Hereinafter, this art is referred to as a second conventional art.
[Patent Document 1] Japanese Utility Model Application Laid-Open No. Hei 01-133895 (claim 1 and FIG. 1)
[Patent Document 2] Japanese Utility Model Registration No. 3074246 (claim 1, [0010], [0011], and FIG. 3)

### DISCLOSURE OF THE INVENTION

### Problems to be Solved by the Invention

In a general dome-shaped speaker, a voice coil wound around a voice coil-supporting member connected to a dome-shaped diaphragm is disposed so as to be vibratable within the magnetic gap of a magnetic circuit, and the diaphragm is fixed to a speaker frame through an edge portion. In the speaker configured as above, when an electric signal is supplied from the outside to the voice coil, a driving force due to magnetic action is generated in the voice coil, and the diaphragm is thereby vibrated to emit a sound wave. In such a dome-shaped speaker, the vibrating member such as the voice coil is generally supported only by the edge portion. Therefore, the rolling of the voice coil and the contact of the voice coil with the magnetic circuit can occur, causing, for example, abnormal sounds and a reduction in acoustic characteristics.

In the configuration of the above first conventional art, the damper is provided in addition to the edge portion to reduce rolling. In the above second conventional art, the voice coil is extended downward, and a surround (edge portion) is disposed at the lower end of the voice coil to reduce rolling. However, in the first conventional art, rolling may not be suppressed sufficiently because of the difference in rigidity, such as Young's modulus, between the edge portion and the damper. In addition, if the damper is provided while the outer diameter of the voice coil is unchanged, the overall size of the speaker device may become large. In the second conventional art, the second surround (edge portion) disposed at the lower end of the voice coil is located below the magnetic gap. Therefore, installation work is complicated, and this results in a difficulty in mass production. Also in the second conventional art, the voice coil has a long length, and this results in an increase in the overall weight of the vibrating member.

The present invention has been made in view of the above circumstances, and an exemplary object of the invention is to solve the foregoing problems. More particularly, it is an object of the invention to provide a speaker device that can solve the foregoing problems and to provide an automobile provided with this speaker device.

### Means for Solving the Problems

To solve the foregoing problems, a speaker device according to the invention of claim 1 includes a vibrating body, a magnetic circuit, and a frame that supports the vibrating body and the magnetic circuit, wherein the vibrating body includes a diaphragm, a voice coil-supporting member that includes a voice coil wound therearound, and a plurality of edge portions that support the voice coil-supporting member vibratably on the frame, and wherein the plurality of edge portions are substantially identical and disposed above the magnetic circuit.

### BRIEF DESCRIPTION OF THE DRAWINGS

FIG. 1 is a cross-partial view illustrating the structure of a speaker device according to one embodiment of the present invention.

FIG. 2 is a partially enlarged view of FIG. 1.

FIG. 3 is a schematic diagram illustrating the flow of air in the speaker device shown in FIG. 1.

FIG. 4(a) is a perspective view of a voice coil-supporting member according to another embodiment of the present invention, and FIG. 4(b) is a perspective view of a voice coil-supporting member according to yet another embodiment of the present invention.

FIG. 5 is a cross-partial view illustrating the structure of a door of an automobile in which the speaker device according in the one embodiment of the present invention is installed.

### BEST MODE FOR CARRYING OUT THE INVENTION

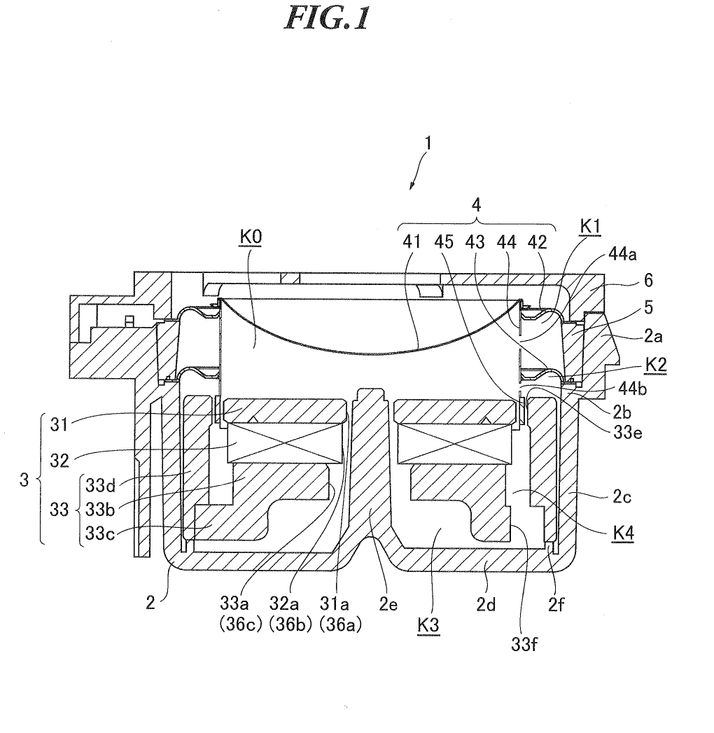

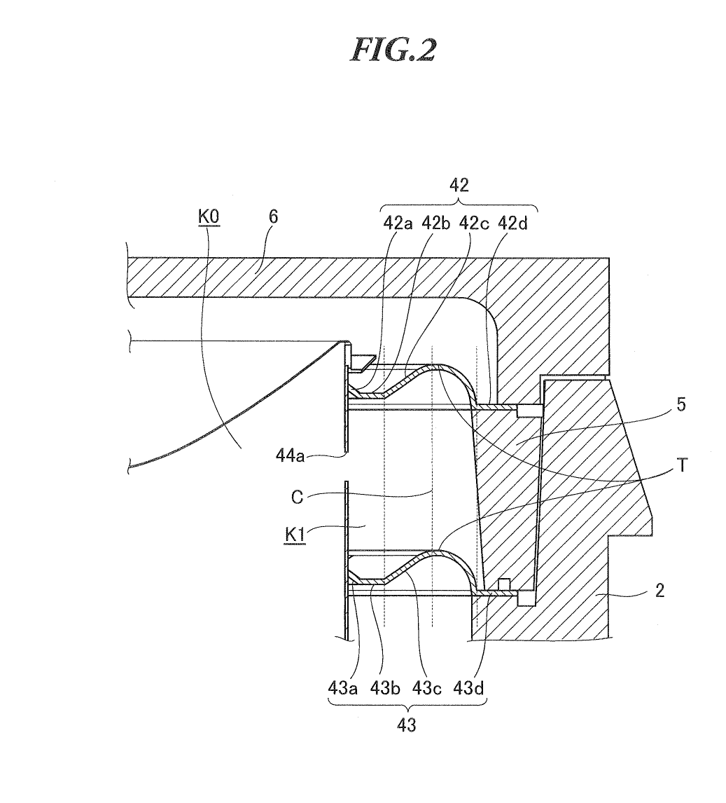

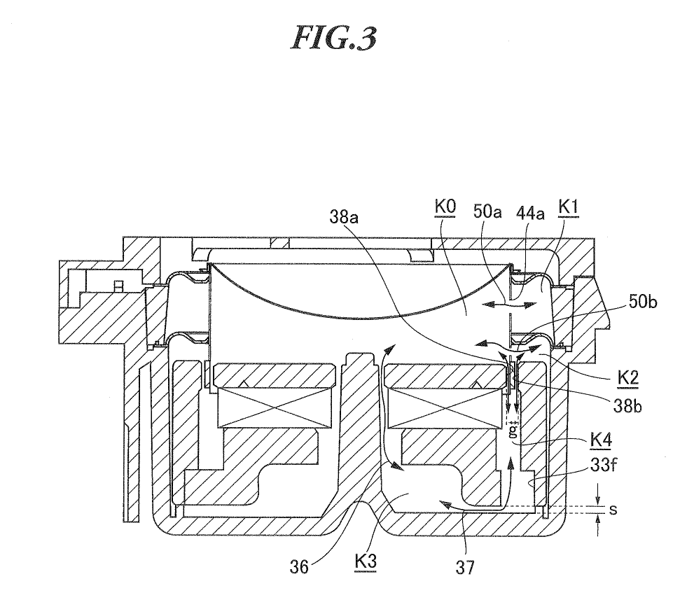

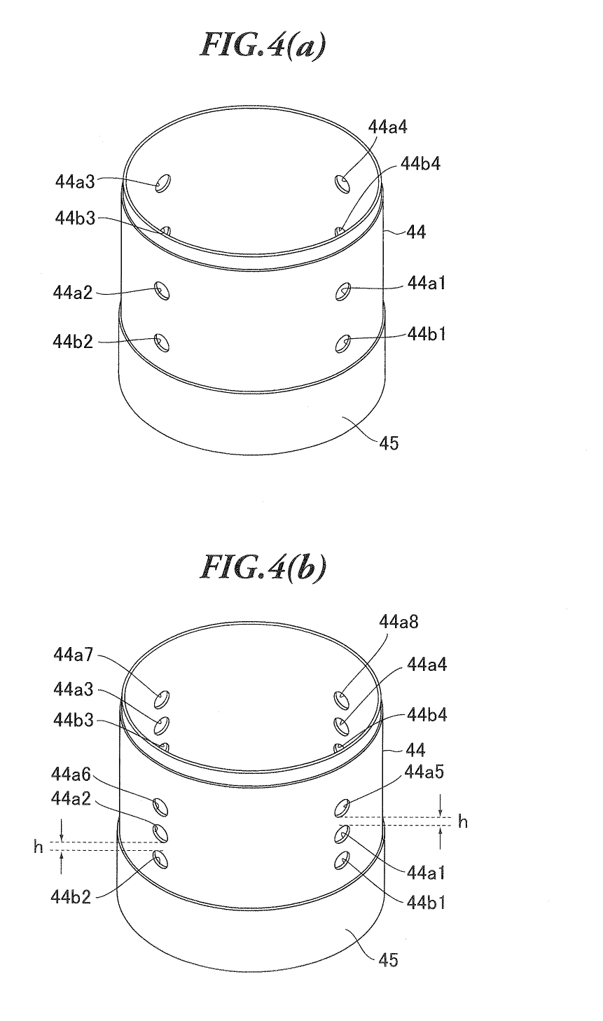

FIG. 1 is a cross-partial view illustrating the structure of a speaker device 1 according to one embodiment of the present invention, FIG. 2 is a partially enlarged view of FIG. 1, FIG. 3 is a schematic diagram illustrating the flow of air in the speaker device shown in FIG. 1, and FIG. 4 is a set of perspective views illustrating the structure of voice coil-supporting members according to embodiments of the present invention. The speaker device 1 includes a frame 2, a magnetic circuit 3, and a vibrating body 4. The frame 2 plays a role of a base of the speaker device 1.

The frame 2 is formed of, for example, an iron-series metal, a non-ferrous metal, an alloy thereof, or a synthetic resin. Examples of the iron-series metal include pure iron, oxygen-free steel, and silicon steel. Examples of the non-ferrous metal include aluminum, magnesium, and zinc. Examples of the synthetic resin include thermoplastic resins such as olefin-series thermoplastic resins (for example, polypropylene), ABS (acrylonitrile-butadiene-styrene) thermoplastic resins, and polyethylene terephthalate-series thermoplastic resins. The frame 2 is formed by, for example, draw forming of an iron-series metal, die-casting of a non-ferrous metal or an alloy thereof, or injection molding of a synthetic resin.

The frame 2 has a substantially concave overall shape and includes, from top to bottom: a cover-supporting part 2a for supporting a cover 6; a support attachment part 2b to which an annular support 5 for supporting the vibrating body 4 is attached; a side surface 2c that surrounds the entire magnetic circuit 3; and a bottom part 2d on which the magnetic circuit 3 is placed. A center pole 2e extending in the direction of acoustic radiation is disposed in the central portion of the bottom part 2d. The bottom part 2d has an annular protruding part 2f formed near its outer circumferential bottom edge. Since the magnetic circuit 3 is placed on the protruding part 2f, a gap s is formed on the inner side of the protruding part 2f and extends between the bottom part 2d and the magnetic circuit 3 (see FIG. 3). The center pole 2e is formed into a substantially cylindrical shape with a convex projection formed at its apex and passes through the central portion of the magnetic circuit 3.

The cover 6 has a plurality of sound emission holes for emitting a sound wave generated by a diaphragm 41 or an edge portion 42. The cover 6 is attached to the frame 2 so as to cover the diaphragm 41 and the edge portion 42.

The vibrating body 4 includes the diaphragm 41, the edge portion 42, an edge portion 43, a voice coil-supporting member 44, and a voice coil 45. The diaphragm 41 has an inverted dome shape. The outer circumferential edge of the diaphragm 41 is bonded with, for example, an adhesive to the outer circumferential surface of the voice coil-supporting member 44 near its upper end, and the diaphragm 41 is concave toward the inner side of the voice coil-supporting member 44. The outer circumferential end part of the diaphragm 41 includes: a downward extending part extending downward along the voice coil-supporting member 44; and an outer circumferential side part extending from the downward extending part toward the edge portion 42. The diaphragm 41, particularly the downward extending part, is bonded with, for example, an adhesive to the outer circumferential side-surface of the voice coil-supporting member 44.

The shape of the diaphragm 41 is not particularly limited to the inverted dome shape and may be any of a dome shape, a flat shape, and other shapes.

Examples of the material for the diaphragm 41 include paper, fiber woven fabrics, fiber knitted products, non-woven fabrics, fiber woven fabrics impregnated with binding resin such as silicone resin, metal materials, synthetic resins, acrylic foams, and hybrid materials formed of a synthetic resin and a metal. Examples of the metal materials include aluminum, titanium, duralumin, beryllium, magnesium, and alloys thereof. Examples of the synthetic resins include polypropylene, polyethylene, polystyrene, polyethylene terephthalate, polyethylene naphthalate, polyarylate, polymethyl methacrylate, polycarbonate, and epoxy resin. The acrylic foams are formed using, for example, methyl methacrylate, methacrylic acid, styrene, maleic anhydride, and methacrylamide as raw materials.

Examples of the material for the voice coil-supporting member 44 that can be used include metal materials and synthetic resins. Specific examples of the material for the voice coil-supporting member 44 that can be used include non-breathable materials such as metals such as aluminum and duralumin and a resin film such as a polyimide film.

In the voice coil-supporting member 44 formed into a cylindrical shape, the diaphragm 41 is bonded to its outer circumferential surface near the upper end, and the voice coil 45 is wound around the outer circumferential surface near the lower end (i.e., near the magnetic circuit 3 side). The ends of the voice coil 45 are electrically connected to the ends of a pair of lead wires (not shown). The voice coil-supporting member 44 is bonded with, for example, an adhesive near its upper end and near its central portion to the inner circumference of the edge portion 42 and the inner circumference of the edge portion 43, respectively. These edge portions 42 and 43 are fixed to the support attachment part 2b of the frame 2 through the support 5, and the voice coil-supporting member 44 is thereby supported on the frame 2. The voice coil-supporting member 44 is elastically held by the edge portions 42 and 43 such that the voice coil 45 is disposed within a magnetic gap g (see FIG. 3) described later. When the speaker device 1 is in a driven state, the edge portions 42 and 43 also serve to support the diaphragm 41, the voice coil-supporting member 44, and the voice coil 45 elastically in a vibration direction (vertical direction).

As shown in FIG. 2, the edge portions 42 and 43 include, respectively: upward extending parts 42a and 43a that are upward bonded to the voice coil-supporting member 44 at a certain angle; flat parts 42b and 43b that extend horizontally from the outer circumferential edges of the upward extending parts 42a and 43a; curved parts 42c and 43c that extend from the outer circumferential edges of the flat parts 42b and 43b and curve in convex shapes; and flat parts 42d and 43d that extend horizontally from the outer circumferential edges of the curved parts 42c and 43c. The edge portions 42 and 43 have substantially lateral S-shaped cross-sections. The flat part 42d is sandwiched between the upper end of the support 5 and the lower end of the cover 6, and the flat part 43d is sandwiched between the lower end of the support 5 and the upper end of the support attachment part 2b. The inner side-surface of the support 5 is formed so as to be inclined outward from top to bottom, and therefore most of the bottom surface of the flat part 42d is in contact with the support. However, the upper surface of the flat part 43d is partially exposed near the curved part 43c side.

In the edge portions 42 and 43, the flat parts 42d and 43d are located lower than the flat parts 42b and 43b, respectively. This arrangement, in which the flat parts 42d and 43d are located lower than the flat parts 42b and 43b, can suppress the occurrence of rolling of the diaphragm 41 and other phenomena, and the edge portions 42 and 43 can thereby vibratably support the diaphragm 41.

The edge portions 42 and 43 move so as to follow the vibration of the diaphragm 41. Therefore, predetermined spaces must be provided below and above the edge portion 42.

The cross-sectional shape of the inner surface of the cover 6 is curved near the edge portion 42, and a predetermined space is formed between the edge portion 42 and the cover 6.

Since the inner side-surface of the support 5 is inclined outward from top to bottom, a predetermined space is formed between the edge portion 43 and the support 5.

Therefore, the edge portions 42 and 43 can move so as to follow the vibration of the diaphragm 41.

The apex T of the curved parts 42c and 43c is located on the outer side of a center line C that bisects the horizontal distances between opposite ends of the curved parts 42c and 43c. In this arrangement, the apex T that has large curvature and receives a relatively large force is located at a position spaced away from the voice coil-supporting member 44. Therefore, even when the diaphragm 41 vibrates with a large amplitude, the edge portions 42 and 43 can follow the vibration of the diaphragm 41. In addition, the amplitude of the diaphragm 41 can be relatively large, and a reproduced sound can be provided at high volume levels.

The edge portion 42 and the edge portion 43 are formed of substantially the same material and have substantially the same shape. Therefore, their rigidities are substantially the same, and their behaviors are substantially the same. Since the voice coil-supporting member 44 is supported by two forces with the same magnitude, the rolling of the voice coil-supporting member 44 can be effectively suppressed, and the occurrence of abnormal sounds and other phenomena caused by the contact of the voice coil 45 with a plate 31 or other members within the magnetic gap g can thereby be suppressed. Since the attachment positions of the edge portions 42 and 43 are higher than the position of the magnetic gap g, the edge portions 42 and 43 can be attached to the voice coil-supporting member 44 without any difficulty, and this can facilitate the production thereof.

A known material for an edge portion, having substantially no breathability or relatively smaller breathability than a material for forming a damper, such as rubber, resin-series sheet material, polyester fiber, or aramid fiber, is selected as the material for the edge portions 42 and 43. As shown in FIG. 1, an annular space K1 is formed by the edge portions 42 and 43, the voice coil-supporting member 44, and the support 5. In addition, a substantially annular space K2 is formed by the edge portion 43, the voice coil-supporting member 44, the case side-surface 2c, and a yoke side-part 33d described later.

The voice coil-supporting member 44 is supported on the frame 2 through the edge portions 42 and 43 at positions higher than the wound voice coil 45. The overall length (in the vibration direction of the diaphragm 41) of the voice coil-supporting member 44 is less than the overall length (in the vibration direction of the diaphragm 41) of the speaker 1. The overall height of the voice coil-supporting member 44 is set such that its lower end is located near the lower surface of the plate 31 or the upper surface of a magnet 32 that are included in the magnetic circuit 3 described later.

The voice coil-supporting member 44 is supported on the frame 2 through the edge portions 42 and 43 at positions higher than the voice coil 45, so that the rolling of the voice coil-supporting member 44 caused by the vibration propagating therethrough can be suppressed. Therefore, rolling that is caused by the natural vibration generated in the voice coil-supporting member and can occur in the second conventional art (i.e., rolling with the antinode of the natural vibration located at the position of the voice coil) can be prevented from occurring, and the voice coil can be prevented from coming into contact with the magnetic circuit or other members.

The voice coil-supporting member 44 forms an internal space K0 that is covered from above with the diaphragm 41 and from below with the plate 31 and the center pole 2e. The voice coil-supporting member 44 has a first air hole 44a that is formed between the edge portion 42 and the edge portion 43 at a predetermined height. The voice coil-supporting member 44 further has a second air hole 44b formed at a predetermined height so as to be located lower than the edge portion 43 and higher than the upper end of the yoke side-part 33d. The formation of the first air hole 44a and the second air hole 44b allows the space K1 to be in communication with the internal space K0 of the voice coil 44 through an air passage 50a formed by the first air hole 44a, as shown in FIG. 3. In addition, the space K2 is in communication with the internal space K0 of the voice coil 44 through an air passage 50b formed by the second air hole 44b.

The position of the formed air hole 44a and the position of the formed air hole 44b are substantially the same in a circumferential direction. More specifically, the air hole 44a is formed directly above the air hole 44b. A plurality of air holes 44a and a plurality of air holes 44b may be formed. In such a case, it is preferable that the air holes 44b are formed at substantially the same height at substantially regular intervals in the circumferential direction and that the air holes 44a are formed directly above the air holes 44b. For example, when four air holes 44a and four air holes 44b are formed as shown in FIG. 4(a), it is preferable that air holes 44b1, 44b2, 44b3, and 44b4 are formed at substantially the same height at about 90 degree intervals in the circumferential direction and that air holes 44a1, 44a2, 44a3, and 44a4 are formed at substantially the same height and located directly above the air hole 44b1, 44b2, 44b3, and 44b4, respectively. Three air holes 44a and three air holes 44b may be formed and may be disposed at about 120 degree intervals in the circumferential direction.

When eight air holes 44a and four air holes 44b are formed as shown in FIG. 4(b), it is preferable that the air holes 44a are vertically arranged in two rows and the air holes 44b are arranged in a single row. Preferably, air holes 44b1, 44b2, 44b3, and 44b4 are formed at the same height at 90 degree intervals in the circumferential direction. Preferably, air holes 44a1, 44a2, 44a3, and 44a4 are formed directly above the air holes 44b1, 44b2, 44b3, and 44b4 with a height space h therebetween, respectively, and air holes 44a5, 44a6, 44a7, and 44a8 are formed directly above the air holes 44a1, 44a2, 44a3, and 44a4 with a height space substantially the same as the height space h therebetween, respectively.

The provision of the first air holes 44a can prevent air in the space K1 from being compressed and can allow the air to flow efficiently. Therefore, the vibration of the diaphragm 41 is not suppressed, and distortion or the like of the acoustic characteristics is prevented from occurring. The provision of the second air holes 44b allows air compressed in the space K2 to escape and flow. In this manner, the suppression of the vibration of the diaphragm 41 due to the compression of air in the space K2 can be reduced. The provision of the air holes 44a and 44b can prevent an increase in temperature of members around the voice coil 45 (such as the plate 31, the magnet 32, and the edge portions 42 and 43, particularly the upward extending parts 42a and 43a) due to the flow of air heated by the Joule heat of the voice coil 45. In particular, the occurrence of high temperature demagnetization of the magnet 32 and deterioration and peeling of the upward extending parts 42a and 43a can be prevented. In addition, a chamber (air chamber) below the diaphragm 41 can be increased in size, and the minimum resonance frequency f₀ can be reduced.

Preferably, the first air holes 44a and the second air holes 44b are formed into circular shapes with substantially the same size. Preferably, the air holes are formed at substantially regular intervals in the circumferential direction and also at substantially regular intervals in the height direction. With this configuration of the air holes 44a and 44b described above, the voice coil 45 is less likely to be distorted when compared with the case where the formed positions of the air holes are displaced in the circumferential direction or their height positions are not constant, so that the vibration of the voice coil can be evenly transmitted to the diaphragm 41.

The inner side-surface of the support 5 is inclined outward from top to bottom. By inclining the inner side-surface of the support 5 outwardly from top to bottom as described above, the flow of air in the space K1 is more facilitated, and the diaphragm 41 can be vibrated efficiently. In particular, since the support 5 is inclined from top to bottom toward the outer side of the edge portions, the flow of air is allowed without suppression of the vibration of the diaphragm 41 caused by the flow of air toward the diaphragm 41.

The magnetic circuit 3 is formed by stacking the plate 31, the magnet 32, and a yoke 33 with their center axes aligned with each other. The plate 31 is made of a magnetic material such as iron and formed into a disk-like shape having at its center a through-hole 31a with a diameter larger than the diameter of the center pole 2e, and the upper and lower edges of the inner and outer circumferential surfaces of the plate 31 are chamfered. The magnet 32 is a permanent magnet such as a rare-earth, samarium-cobalt, alnico, or ferrite magnet and is formed into a disk-like shape having a through-hole 32a with a diameter larger than the diameter of the through-hole 31a, and the outer diameter of the magnet 32 is smaller than that of the plate 31. The yoke 33 is made of a magnetic material such as pure iron, oxygen-free steel, or silicon steel and includes: a disk-shaped protruding part 33b having at its center a through-hole 33a with a diameter greater than that of the through-hole 32a; a yoke bottom part 33c that supports the outer circumference of the protruding part 33b; and the yoke side-part 33d that extends upward from the outer circumference of the yoke bottom part 33c to the height of the plate 31 and serves as the side surface of the magnetic circuit 3. The outer diameter of the yoke protruding part 33b is substantially similar to or smaller than that of the magnet 32, and the outer diameter of the yoke bottom part 33c is substantially similar to or greater than that of the plate 31. The inner diameter of the yoke side-part 33d is greater than the outer diameters of the plate 31, the magnet 32, and the protruding part 33b.

A protruding part 33e is provided at the upper end of the inner circumferential surface of the yoke side-part 33d. The protruding part 33e is chamfered. The inner diameter of the protruding part 33e is slightly larger than the outer diameter of the plate 31. In this configuration, the magnetic gap g, which is a slight gap, is formed between the outer circumferential surface of the plate 31 and the upper-end inner circumferential surface of the yoke side-part 33d, as shown in FIG. 3. As described above, the voice coil 45 is disposed within the magnetic gap g. Therefore, the magnetic gap g is divided by the voice coil 45 into an inner portion and an outer portion.

The yoke side-part 33d has an inwardly recessed portion that is a part of its inner circumferential side-surface facing the outer circumferential side-surface of the yoke bottom part 33c, and the recessed portion and the yoke bottom part 33c are fitted with each other. A plurality of annular or circumferential through-hole portions 33f described later are formed near the recessed portion of the yoke side-part 33d.

The magnetic circuit 3 configured as above is placed on the protruding part 2f within the frame 2. Therefore, an air ventilation gap s is formed on the inner side of the protruding part 2f and extends between the bottom part 2d and the magnetic circuit 3.

Since the outer circumferential surface of the yoke protruding part 33b is supported by the yoke bottom part 33c as described above, an annular space K3 is formed by the inner surface of the frame 2, the bottom surface of the yoke protruding part 33b, and the inner circumferential surface of the yoke bottom part. Since the inner diameter of the yoke side-part 33d is larger than the outer diameters of the plate 31, the magnet 32, and the protruding part 33b, an annular space K4 is formed by the outer circumferential surface of the magnet 32, the inner circumferential surface of the yoke side-part 33d, the outer circumferential surface of the protruding part 33b, and the upper surface of the yoke bottom part 33c.

The center pole 2e passes through the through-holes 31a, 32a, and 33a, and annular air passages 36a, 36b, and 36c are formed between the center pole 2e and the plate 31, the magnet 32, and the yoke 33, respectively. The air passage 36b is wider than the air passage 36a, and the air passage 36c is wider than the air passage 36b. An air passage 36 is formed by the air passages 36a, 36b, and 36c. As shown in FIG. 3, the space K3 is in communication with the internal space K0 of the voice coil-supporting member through the air passage 36. Since the through-holes 33f are provided in a part of the yoke bottom part 33c so as to be located near the boundary with the yoke side-part 33d, the space K3 is in communication with the space K4 through an air passage 37 formed by the gap s and the through-holes 33f. The space K4 is in communication with the internal space K0 of the voice coil-supporting member through an air passage 38a, which is a portion on the inner side of the voice coil 45 within the magnetic gap g, or in communication with the space K2 through an air passage 38b, which is a portion on the outer side of the voice coil 45 within the magnetic gap g. Since the protruding part 33e and the upper and lower edges of the outer circumference of the plate 31 are chamfered, the flow of air in the air passages 38a and 38b is facilitated. Also, since the upper and lower edges of the inner circumference of the plate 31 are chamfered, the flow of air in the air passage 36 is facilitated.

Meanwhile, in one conventional speaker device, a space is provided between the inner circumferential surface of a speaker case and the outer circumferential surface of a magnetic circuit unit, and this space is in communication with an internal space provided between a diaphragm and the magnetic circuit, whereby a large chamber is formed within the speaker case (see, for example, Japanese Patent Application Laid-Open No. 2007-181120). Hereinafter, this art is referred to as a third conventional art.

In another conventional speaker device, a space formed by a voice coil-supporting member, an edge portion, a magnetic circuit, and a frame is allowed to be in communication with an internal space provided between a diaphragm and the magnetic circuit by providing air holes in the voice coil-supporting member (for example, WO2008/004272). Hereinafter, this art is referred to as a fourth conventional art.

In a general dome-shaped speaker, a voice coil wound around a voice coil connected to a dome-shaped diaphragm is disposed so as to be vibratable within the magnetic gap of a magnetic circuit, and the diaphragm is fixed to a speaker frame through an edge portion. In the speaker configured as above, when an electric signal is supplied from the outside to the voice coil, a driving force due to magnetic action is generated in the voice coil, and the diaphragm is thereby vibrated to emit sound waves. In such a dome-shaped speaker, a space called a chamber may be provided on the rear side of the speaker to reduce the minimum resonance frequency f₀. However, when the chamber is provided on the rear side of the speaker, the thickness of the speaker itself becomes large. Therefore, it is difficult to reduce the size of the speaker while the minimum resonance frequency f₀ is reduced to obtain good acoustic characteristics.

In the third conventional art, the formation of the chamber allows a reduction in the minimum resonance frequency f₀ while a reduction in size is achieved. In the fourth conventional art, the compression of air in the space formed by the voice coil-supporting member, the edge portion, the magnetic circuit, and the frame is reduced, and good acoustic characteristics can thereby be obtained. However, in both of these conventional arts, when the diaphragm vibrates with a large amplitude at about the minimum resonance frequency f₀, air in a locally formed small space (e.g. a space formed below the edge portion in the third conventional art and a space formed around the outer circumference of the magnet in the fourth conventional art) is repeatedly compressed and expanded. Therefore, the downward vibration of the diaphragm is suppressed particularly when the air is compressed, and this may cause distortion of the acoustic characteristics.

To solve the above problem, for example, in the exemplary configuration described above, the space K3 is in communication with the internal space K0. This allows a large chamber size to be ensured, and the minimum resonance frequency f₀ can thereby be reduced. The space K4 is also in communication with the internal space K0. This also allows a large chamber size to be ensured, and the minimum resonance frequency f₀ can thereby be reduced. Since the space K4 is in communication also with the space K2, the flow of air therebetween occurs, and the suppression of the vibration of the diaphragm 41 caused by compression of air in the space K2 can thereby be reduced. Since the space K3 and the space K4 are in communication with each other, these spaces plays a role of a large chamber, and the minimum resonance frequency f₀ can thereby be reduced. Since the space K3, the space K4, and the internal space K0 are in communication with each other, an air circulation path is established. Therefore, the suppression of the downward vibration of the diaphragm 41 caused by compressed air can be effectively prevented.

In the speaker device 1 according to the above embodiment, the edge portions 42 and 43 having substantially the same shape and formed of substantially the same material are disposed above the magnetic gap g, and this allows two-point mounting with substantially the same rigidity. Therefore, the rolling of the voice coil 45 can be effectively suppressed, and the occurrence of abnormal sounds and other phenomena caused by the contact of the voice coil 45 with the plate 31 or other members within the magnetic gap g can thereby be suppressed.

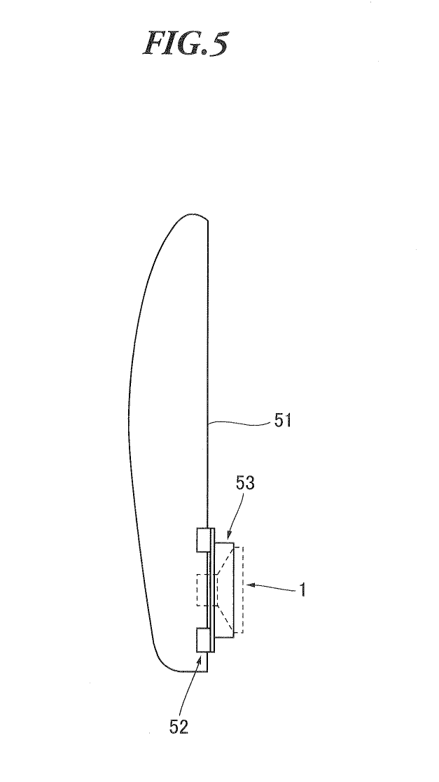

FIG. 5 is a cross-partial view illustrating the structure of a door 51 of an automobile in which the speaker device 1 according to one of the embodiments of the present invention is installed. In FIG. 5, a bracket 52 is disposed on the rear side of the door 51, and a unifying member 53 is installed on the front side of the door 51. The speaker device 1 is attached through the unifying member 53.

The embodiments of the present invention have been described with reference to the drawings, but the specific configuration is not limited to these embodiments. Various design modifications and other modifications are included in the present invention so long as they do not depart from the gist of the present invention.

For example, in the above exemplary embodiments, the diaphragm 41 has an inverted dome shape, but the invention is not limited thereto. A regular dome shape convex upward may be used. However, the inverted dome shape allows a further reduction in the overall size of the speaker device.

In the above exemplary embodiments, the shapes of the edge portions 42 and 43 are substantially the same, and the materials therefor are also substantially the same. However, the invention is not limited thereto. For example, different shapes and different materials can be used so long as the resultant rigidities and other properties are not significantly different and these differences do not cause an extreme difference in the behaviors of the edge portions. When the shapes and also the materials are substantially the same, the number of types of components does not increase, and this simplifies production. In the above exemplary embodiments, the curved parts of the edge portions 42 and 43 are convex upward, but the invention is not limited thereto. For example, the curved part of the edge portion 42 may be convex upward and the curved part of the edge portion 43 may be convex downward, and vice versa. In the above exemplary embodiments, the diaphragm 41 is provided separately from the voice coil-supporting member 44, but they may be formed integrally. In addition, a plurality of through-holes 33f may be formed in the yoke 33.

1. A speaker device comprising: a vibrating body; a magnetic circuit; and a frame that supports said vibrating body and said magnetic circuit,
wherein said vibrating body includes a diaphragm, a voice coil-supporting member that includes a voice coil wound therearound, and a plurality of edge portions that support said voice coil-supporting member vibratably on the frame, and
wherein said plurality of edge portions are substantially identical and disposed above said magnetic circuit.

2. The speaker device according to claim 1, wherein:
each of said plurality of edge portions has a cross-sectional shape including a curved part, a flat part that surrounds said curved part, and an upward extending part connected to the voice coil-supporting member; and
an apex of said curved part is located on an outer side of a central position of said curved part.

3. The speaker device according to claim 2, wherein an inner circumferential surface of said upward extending part has a shape inclined with respect to a vertical direction.

4. The speaker device according to claim 3, wherein:
a first space surrounded by said frame and said voice coil-supporting member is formed between said plurality of edge portions;
said voice coil-supporting member has an air hole provided in a side surface thereof; and
said first space is in communication with an internal space on an inner side of said voice coil-supporting member through said air hole.

5. The speaker device according to claim 4, wherein;
a first space surrounded by said frame and said voice coil-supporting member is formed between said plurality of edge portions;
a second space is formed which is surrounded by said magnetic circuit, said frame, and one of said plurality of edge portions, the one of the plurality of edge portions being disposed on a magnetic circuit side; and
said voice coil-supporting member has the air hole comprising a plurality of air holes provided in the side surface thereof, said first space and the internal space on the inner side of said voice coil-supporting member is in communication with each other through at least one of said plurality of air holes, and said second space and the internal space on the inner side of said voice coil-supporting member is in communication with each other through at least another one of the plurality of air holes.

6. The speaker device according to claim 5, wherein:
said frame includes a pole extending from a bottom portion thereof in a direction of acoustic radiation;
said magnetic circuit is formed into an annular shape;
an air passage is formed between said pole and said magnetic circuit; and
a third space is formed between said magnetic circuit and said frame, the third space being in communication with said internal space through said air passage.

7. The speaker device according to claim 6, wherein:
said magnetic circuit includes, as a component thereof, a yoke having a bottom portion protruding in the direction of acoustic radiation; and
said third space is formed between said yoke and said frame.

8. The speaker device according to claim 7, wherein
said magnetic circuit include, as a component thereof, a yoke having a through-hole portion formed in a bottom portion of the yoke;
said frame has on a bottom portion thereof a protruding portion that supports said magnetic circuit, whereby a gap is formed between the frame and said yoke;
said magnetic circuit further includes as components thereof a plate and a magnet, a fourth space being formed between said yoke and one of the plate and the magnet; and
said internal space is in communication with said fourth space.

9. The speaker device according to claim 6, wherein:
said yoke has a through-hole portion formed in a bottom portion thereof;
said frame has on a bottom portion thereof a protruding portion that supports said magnetic circuit, whereby a gap is formed between said frame and said yoke;
said magnetic circuit further includes as components thereof a plate and a magnet, a fourth space being formed between said yoke and one of the plate and the magnet; and
said internal space is in communication with said fourth space through said third space, said gap of said yoke, and the through-hole portion.

10. The speaker device according to claim 5, wherein said plurality of air holes are arranged at substantially regular intervals in circumferential and height directions of the voice coil-supporting member.

11. The speaker device according to claim 8, wherein said second space and said fourth space are in communication with each other through a gap between said yoke and said plate.

12. The speaker device according to claim 1, wherein said diaphragm is formed into a curved shape.

13. The speaker device according to claim 1, wherein an inner circumferential portion of said diaphragm of said vibrating body is attached to an outer circumferential portion of said voice coil-supporting member.

14. The speaker device according to claim 1, wherein at least said diaphragm and said voice coil-supporting member of said vibrating body are integrally formed.

15. An automobile comprising said speaker device according to claim 1.
